(19) United States
(12) Patent Application Publication
(10) Pub. No.: US 2011/0241945 A1
(43) Pub. Date: Oct. 6, 2011

(54) MULTIPLE-BAND ANTENNA

(75) Inventor: MENG-GANG ZHAO, Shenzhen City (CN)

(73) Assignees: FU TAI HUA INDUSTRY (SHENZHEN) CO., LTD., ShenZhen City (CN); HON HAI PRECISION INDUSTRY CO., LTD., Tu-Cheng (TW)

(21) Appl. No.: 12/871,927

(22) Filed: Aug. 31, 2010

(30) Foreign Application Priority Data
Mar. 31, 2010 (CN) 201010137046.X

(51) Int. Cl. H01Q 1/38

(52) U.S. Cl. 343/700 MS

(57) ABSTRACT

A multiple-band antenna includes a planar substrate, a feed back line, a first and a second antenna body. The feedback line is configured for receiving wireless communication signals. The first antenna body includes a feedback terminal connected to the feedback line and a ring structure connected to the feed back terminal. The ring structure is divided into a left and a right arc portion by an axis line of the feedback terminal, the left arc portion cooperates with the feedback terminal to form a first antenna structure, and the right arc portion cooperates with the feedback terminal to form a second antenna structure, the first and the second antenna structure are configured for working in a first and a second frequency band respectively. The second antenna body is configured for working in a third frequency band by coupling the first and the second antenna structure.

### BACKGROUND

1. Technical Field

The present disclosure relates to antennas and, particularly, to a multiple-band antenna.

2. Description of Related Art

Nowadays, electronic devices such as mobile phones are widely used. To satisfy user's needs, a type of mobile phone which can support multiple subscriber identity module (SIM) cards has been developed. Usually, these SIM cards work in different frequency bands, therefore, corresponding number of antennas are needed, which increases the volume of the electronic device.

Therefore, it is desirable to provide a multiple-band antenna to overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a front view of a multiple-band antenna in accordance with an exemplary embodiment.

FIG. 2 is a back view of the multiple-band antenna of FIG. 1.

FIG. 3 is a schematic view showing the electrical characteristic of the multiple-band antenna of FIG. 1.

### DETAILED DESCRIPTION

Embodiments of the present disclosure will now be described in detail below, with reference to the accompanying drawings.

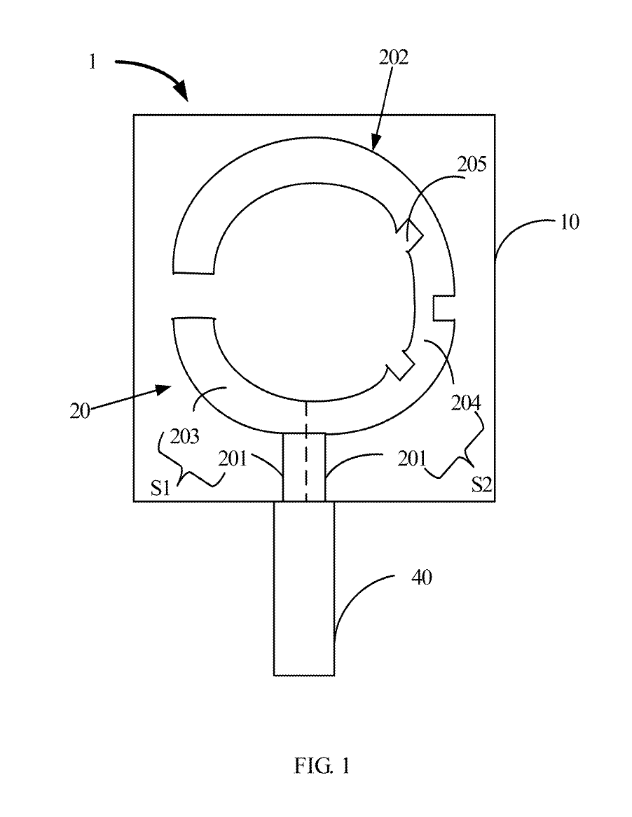

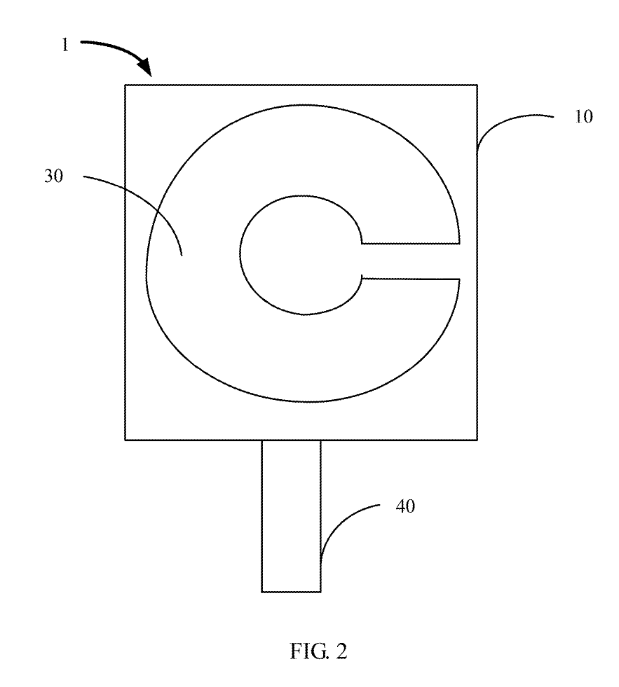

Referring to FIG. 1 and FIG. 2, a multiple-band antenna 1 (hereinafter antenna 1) includes a planar substrate 10, a first antenna body 20, a second antenna body 30 and a feedback line 40. The first antenna body 20 and the second antenna body 30 are respectively located at a front side and a back side of the planner substrate 10. The feedback line 40 is configured for receiving wireless communication signals. In the embodiment, the planar substrate 10 is made of insulating material, such as plastic, and is substantially rectangular. In the embodiment, the size of the planner 10 is about 38 mm (length)*60 mm (breadth)*1 mm (thickness). The first antenna body 20 is a ring structure with an opening (not labeled) and includes a feedback terminal 201 and a ring structure 202 which are connected to each other. The feedback terminal 201 is connected to the feedback line 40. In the embodiment, the axis of the feedback line 40 divides the ring structure 202 into a left arc portion 203 and a right arc portion 204. The length of the left arc portion 203 is about a quarter of the ring structure 202, the length of the right arc portion 204 is about three quarters of the ring structure 202. The feedback terminal 201 cooperates with the left arc portion 203 to form a first antenna structure S1, and the feedback terminal 201 cooperates with the right arc portion 204 to form a second antenna structure S2. The first antenna structure S1 is configured for transmitting or receiving a first wireless communication signal with a first frequency band f1, and the second antenna structure S2 is configured for transmitting or receiving a second wireless communication signal with a second frequency band f2. Namely, the first and the second antenna structure S1, S2 respectively works in the first frequency band f1, f2.

As shown in FIG. 2, the second antenna body 30, which is located at the back of the antenna 1, is a ring structure with a opening (not labeled) and is configured for receiving a third wireless communication signal with a third frequency band f3. Namely, the second antenna body 30 works in the third frequency band f3. The openings of the first antenna body 20 and the second antenna body 30 point in an orientation towards the same direction. The second antenna body 30 is configured for transmitting or receiving a third wireless communication signal with a third frequency band by coupling with the first antenna structure S1 and the second antenna structure S2.

In the embodiment, the lengths of the first antenna structure S1, the second antenna structure S2, and the second antenna body 30 can be changed according to needed frequency bands supported by the antenna 1.

In the embodiment, the antenna 1 is a Worldwide Interoperability for Microwave Access (Wimax) antenna, and the range of the first frequency band f1 is from 5.2 Gigahertz (GHz) to 5.8 GHz. The range of the second frequency band f2 is from 2.4 GHz to 2.7 GHz, and the range of the third frequency band f3 is from 3.3 GHz-3.8 GHz. It is known that f (frequency)*λ (wavelength)=v (wave velocity), and if attempting to receive and transmit a wireless communication signal with a certain frequency, the length (L) of the antenna is better set to be a quarter of wavelength of the wireless communication signal. Because the wave velocity is a constant, namely 3*10⁸ (m/s), the length of the antenna can be calculated according to the desired frequency band and the wave velocity. Therefore, in the embodiment, the length of the first antenna structure S1 is set to be a quarter of the wavelength of the wireless communication signal with the first frequency band f1, and the length of the second antenna structure S2 is set to be a quarter of the wavelength of the wireless communication signal with the second frequency band f2.

In the embodiment, the length of the feedback terminal 201 is about 4 millimeter mm and the width of the feedback terminal 201 is about 10.5 mm. The length of the left arc portion 203 is about 9.5 mm, and the length of the right arc portion 204 is about 27.5 mm. Therefore, the length of the first antenna structure S1 is about 13.5 mm which equals to the sum of the length of the feedback terminal 201 and the length of the left arc portion 203. The length of the second antenna structure S2 is 31.5 mm which equals to the sum of the length of the feedback terminal 201 and the length of the right arc portion 204. The internal radius R1 of the second antenna body 30 is about 1.5 mm, and the external radius R2 of the second antenna body 30 is about 6 mm. Therefore, the length of the second antenna body 30 is equals to 2π*(R1+R2)/2, namely, the length of the second antenna body 30 is about 23.55 mm which is calculated by 2π*(R1+R2)/2.

In the embodiment, the right arc portion 204 includes a number of slots 205 to increase its length, without increasing the volume of the antenna 1.

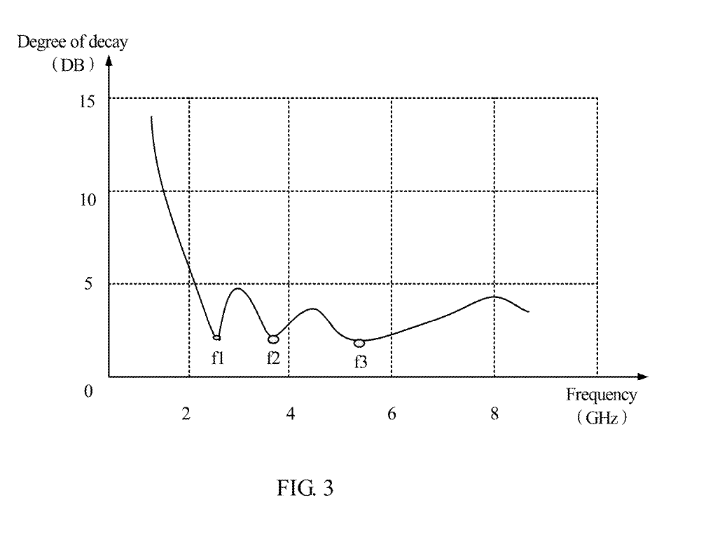

Referring to FIG. 3, when the antenna 1 works in the first frequency band f1, the second frequency band f2, and the third frequency band f3, the degree of decays are the least. Therefore, the antenna 1 is capable of working in the first frequency band f1, the second frequency band f2, and the third frequency band f3 with high signal noise ratio (SNR).

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A multiple-band antenna comprising:
a planar substrate;
a feedback line configured for receiving wireless communication signals;
a first antenna body, located at a front side of the planar substrate, comprising:
a feedback terminal connected to the feedback line; and
a ring structure connected to the feedback terminal, the ring structure being divided into a left arc portion and a right arc portion by an axis of the feedback terminal, the left arc portion cooperating with the feedback terminal to form a first antenna structure configured for transmitting and receiving a first wireless communication signal with a first frequency band, and the right arc portion cooperating with the feedback terminal to form a second antenna structure configured for transmitting and receiving a second wireless communication signal with a second frequency band; and
a second antenna body located at a back side of the planar substrate and configured for transmitting and receiving a third wireless communication signal with a third frequency band by coupling the first antenna structure and the second antenna structure.

2. The multiple-band antenna according to claim 1, wherein the length of the first antenna structure is a quarter of the wavelength of the wireless communication signal with the first frequency band and the length of the second antenna structure is a quarter of the wavelength of the wireless communication signal with the second frequency band.

3. The multiple-band antenna according to claim 2, wherein the right arc portion defines a number of slots.

4. The multiple-band antenna according to claim 1, the antenna is a Worldwide Interoperability for Microwave Access (Wimax) antenna.

5. The multiple-band antenna according to claim 4, wherein the range of the first frequency band is from about 5.2 GHz to about 5.8 GHz, the range of the second frequency band is from about 2.4 GHz to about 2.7 GHz, and the range of the third frequency band is from about 3.3 GHz to about 3.8 GHz.

6. The multiple-band antenna according to claim 1, wherein the planar substrate is made of insulating material and is substantially rectangular.

7. The multiple-band antenna according to claim 1, wherein the internal radius of the second antenna body is R1, the external radius of the second antenna body is R2, and the length of the second antenna body is equals to 2π*(R1+R2)/2.

8. The multiple-band antenna according to claim 2, wherein the length of the feedback terminal is about 4 millimeter (mm) and the length of the left arc portion is about 9.5 mm, the length of the first antenna structure is about 13.5 mm which equals to the sum of the length of the feedback terminal and the length of the left arc portion.

9. The multiple-band antenna according to claim 8, wherein the length of the right arc portion is about 27.5 mm, the length of the second antenna structure is 31.5 mm which equals to the sum of the length of the feedback terminal and the length of the right arc portion.

10. The multiple-band antenna according to claim 7, wherein the length of the internal radius R1 is about 1.5 mm and the length of the external radius R2 is about 6 mm, and the length of the second antenna body is about 27.55 mm calculated by 2π*(R1+R2)/2.
